(19) United States
(12) Patent Application Publication
(10) Pub. No.: US 2012/0183854 A1
(43) Pub. Date: Jul. 19, 2012

(54) PROCESS FOR PRODUCING ELECTRODES FOR LITHIUM-SULFUR BATTERIES

(75) Inventors: Arnd Garsuch, Ludwigshafen (DE); Klaus Leitner, Ludwigshafen (DE); Tobias Joachim Koplin, Ludwigshafen (DE)

(73) Assignee: BASF SE, Ludwigshafen (DE)

(21) Appl. No.: 13/347,058

(22) Filed: Jan. 10, 2012

Related U.S. Application Data
(60) Provisional application No. 61/432,278, filed on Jan. 13, 2011.

(51) Int. Cl. H01M 4/62; B82Y 40/00; B82Y 30/00

(52) U.S. Cl. 429/215; 427/122; 977/742; 977/890; 977/948

(57) ABSTRACT

The present invention relates to a process for producing a cathode, which comprises mixing:
(A) sulfur,
(B) carbon in an electrically conductive polymorph and
(C) at least one saccharide selected from monosaccharides, disaccharides, oligosaccharides and polysaccharides, which is soluble or swellable in an acidic aqueous medium,
   and applying the resulting mixture to a flat carrier (D) and then optionally drying it.

The present invention relates to a process for producing a cathode, which comprises mixing:
(A) sulfur,
(B) carbon in an electrically conductive polymorph and
(C) at least one saccharide selected from monosaccharides, disaccharides, oligosaccharides and polysaccharides, which is soluble or swellable in an acidic aqueous medium,
   and applying the resulting mixture to a flat carrier (D) and then optionally drying it.

The present invention further relates to electrodes comprising
(D) at least one flat carrier,
   and thereon a mixture of
(A) sulfur,
(B) carbon in an electrically conductive polymorph and
(C) at least one saccharide selected from monosaccharides, disaccharides and polysaccharides, which is soluble or swellable in an acidic aqueous medium.

Secondary batteries, accumulators or “rechargeable batteries” are just some embodiments by which electrical energy can be stored after generation and used (consumed) as required. Owing to the significantly better power density, there has been a move in recent times from water-based secondary batteries to development of batteries in which charge transport is accomplished by lithium ions.

However, the energy density of conventional lithium ion accumulators which have a carbon anode and a cathode based on metal oxides is limited. New horizons have been opened up by lithium-sulfur cells. In lithium-sulfur cells, sulfur in the sulfur cathode is reduced via polysulfide ions to S²⁻ ions, which are oxidized again when the cell is charged.

However, it is frequently observed that the sulfur is distributed irregularly over the electrode. This can result in disadvantageous properties, for example poor contacting of the sulfur and hence a low use rate of the electrode. These disadvantages can result in an electrode with low capacity and/or capacity loss.

It was thus an object of the present invention to provide lithium-sulfur cells in which this problem is avoided. It was a further object of the present invention to provide a process for production of lithium-sulfur cells which do not have the disadvantages described above.

Accordingly, the process defined at the outset has been found.

Sulfur (A) is known as such and can also be referred to as sulfur for short in the context of the present invention.

Carbon in an electrically conductive polymorph (B) may, in the context of the present invention, also be referred to as carbon (B). Carbon (B) can be selected, for example, from graphite, carbon black, carbon nanotubes, graphene or mixtures of at least two of the aforementioned substances.

In one embodiment of the present invention, carbon (B) is carbon black. Carbon black may, for example, be selected from lamp black, furnace black, flame black, thermal black, acetylene black and industrial black. Carbon black may comprise impurities, for example hydrocarbons, especially aromatic hydrocarbons, or oxygen-containing compounds or oxygen-containing groups, for example OH groups. In addition, sulfur- or iron-containing impurities are possible in carbon black.

In one variant, carbon (B) is partially oxidized carbon black.

In one embodiment of the present invention, carbon (B) comprises carbon nanotubes. Carbon nanotubes (CNT for short), for example single-wall carbon nanotubes (SW CNTs) and preferably multiwall carbon nanotubes (MW CNTs), are known per se. A process for production thereof and some properties are described, for example, by A. Jess et al. in Chemie Ingenieur Technik 2006, 78, 94-100.

Graphene in the context of the present invention is understood to mean almost ideally or ideally two-dimensional hexagonal carbon crystals which have an analogous structure to individual graphite layers.

In a preferred embodiment of the present invention, carbon (B) is selected from graphite, graphene, activated carbon and especially carbon black.

Carbon (B) may be present, for example, in particles which have a diameter in the range from 0.1 to 100 μm, preferably 2 to 20 μm. The particle diameter is understood to mean the mean diameter of the secondary particles, determined as the volume average.

In one embodiment of the present invention, carbon (B) and especially carbon black has a BET surface area in the range from 20 to 1500 m²/g, measured to ISO 9277.

In one embodiment of the present invention, at least two, for example two or three, different kinds of carbon (B) are mixed. Different kinds of carbon (B) may differ, for example, with regard to particle diameter or BET surface area or degree of contamination.

In one embodiment of the present invention, the carbon (B) selected is a combination of carbon black and graphite.

A further starting material for performance of the process according to the invention is at least one saccharide (C) selected from monosaccharides, disaccharides, oligosaccharides and polysaccharides, the saccharide being soluble or swellable in an aqueous acidic medium, also referred to as saccharide (C) for short. Saccharides soluble in an acidic aqueous medium are preferred.

An acidic aqueous medium is understood to mean aqueous solutions which have a pH of not more than 6.9, for example a pH in the range from 1 to 6.9, preferably in the range from 3 to 6.5.

Acetylcellulose, which is soluble in a basic aqueous medium but is neither swellable nor soluble in an acidic aqueous medium, is not an example of saccharide (C). Starch too is neither swellable nor soluble in an aqueous acidic medium and is not an example of saccharide (C) in the context of the present invention.

“Water-soluble” sugar compounds in the context of the present invention are understood to mean those which form a solution which appears clear to the eye in an acidic aqueous medium. “Water-swellable” sugar compounds in the context of the present invention are understood to mean those which can reversibly absorb at least 100% of their weight of water at a temperature in the range from 20 to 90° C.

In one embodiment of the present invention, saccharides (C) are selected from glucose, fructose, sucrose, mannose and maltose.

In one embodiment of the present invention, saccharides (C) are selected from monosaccharides, especially glucose and fructose.

In one embodiment of the present invention, saccharides (C) are selected from disaccharides, especially sucrose.

In one embodiment of the present invention, saccharides (C) are selected from polysaccharides, especially amylopectin.

In one embodiment of the present invention, saccharides (C) are selected from partially oxidized saccharides, especially from partially oxidized mono- or disaccharides, especially from caramelized sugars, for example caramelized sucrose, caramelized glucose and caramelized fructose.

The procedure for performance of the process according to the invention is first to mix sulfur (A), carbon (B) and at least one saccharide (C) with one another, and to apply the mixture thus obtainable to a flat carrier (D) and then to dry it.

The mixing can be performed by methods known per se, for example by grinding sulfur (A), carbon (B) and at least one saccharide (C) with one another, especially in a ball mill, or by stirring sulfur (A), carbon (B) and at least one saccharide (C) with one another in aqueous suspension. It is also possible to knead sulfur (A), carbon (B) and at least one saccharide (C) with addition of water to give an aqueous paste. Preference is given to combining at least two mixing methods with one another. The procedure is most preferably to grind sulfur (A), carbon (B) and at least one saccharide (C) with one another, for example in a ball mill, and then to suspend them in water or aqueous formulation. In another very particularly preferred embodiment of the present invention, sulfur (A), carbon (B) and at least one saccharide (C) are first stirred with one another in a liquid, for example in water or in a water/alcohol mixture, and then ground, for example in a ball mill.

In one variant of the process according to the invention, the method of mixing selected is the action of ultrasound.

The result of the mixing is that a mixture of sulfur (A), carbon (B) and at least one saccharide (C) is obtained, which may have one or more further constituents, for example water or at least one organic solvent.

In the embodiments in which mixture of sulfur (A), carbon (B) and at least one saccharide (C) further comprises water, reference shall also be made in the context of the present invention to aqueous formulation. Aqueous formulation can be configured as a paste or as an ink.

Aqueous formulation may comprise, for example, 0.1 up to 70% by volume, based on water, of at least one organic solvent, especially in the range from 5 up to 60% by volume. Suitable organic solvents are, for example, water-soluble alcohols, especially methanol, ethanol and isopropanol.

In another embodiment of the present invention, aqueous formulation does not comprise any organic solvent.

In another embodiment of the present invention, mixture of sulfur (A), carbon (B) and at least one saccharide (C) comprises neither water nor organic solvent, but rather is a pulverulent mixture.

In the context of the present invention, those preferably aqueous formulations which have a solids content in the range from 1.1 to 20% by weight are referred to as ink. Those preferably aqueous formulations which have a solids content above 20% by weight up to 45% by weight, preferably at least 20.1% by weight, are referred to as paste.

In one embodiment of the present invention, paste comprises

in the range from 12 to 20% by weight, preferably 13 to 15% by weight, of sulfur (A),
in the range from 8 to 20% by weight, preferably 8 to 12% by weight, of carbon (B),
a total of in the range from 0.1 to 5% by weight, preferably 0.5 to 3.0% by weight, of saccharide (C), where the figures in % by weight are each based on overall paste,
and the sum of percentages by weight of sulfur (A), carbon (B) and saccharide (C) is above 20, preferably at least 20.1.

In one embodiment of the present invention, ink comprises

in the range from 0.5 to 10% by weight, preferably 3.0 to 3.5% by weight, of sulfur (A),
in the range from 0.5 to 9% by weight, preferably 2.5 to 3% by weight, of carbon (B),
a total of in the range from 0.1 to 1.0% by weight, preferably 0.3 to 0.5% by weight, of saccharide (C),
where the figures in % by weight are each based on overall ink
and the sum of percentages by weight of sulfur (A), carbon (B) and saccharide (C) is in the range from 1.1 to 20.

The application of mixture of sulfur (A), carbon (B) and at least one saccharide (C) prepared in the first step to flat carrier (D) can be accomplished, for example, by spraying, for example spraying on or atomization, and also knifecoating, printing, especially by screen printing, or by compressing. In the context of the present invention, atomization also includes application with the aid of a spray gun, a process frequently also referred to as “airbrush method” or “airbrushing” for short.

If the desire is to apply mixture of sulfur (A), carbon (B) and at least one saccharide (C) prepared in the first step by spraying onto flat carrier (D), it is preferable to formulate the mixture as an ink.

If the desire is to apply mixture of sulfur (A), carbon (B) and at least one saccharide (C) produced in the first step by knifecoating or by screen printing onto flat carrier (D), it is preferable to formulate the mixture as a paste.

In one embodiment of the present invention, flat carrier (D) is a medium which conducts the electrical current, for example an output conductor.

In a preferred embodiment of the present invention, flat carrier (D) is chemically inert with respect to the reactions which proceed in an electrochemical cell in standard operation, i.e. in the course of charging and in the course of discharging.

In one embodiment of the present invention, flat carrier (D) has an internal BET surface area in the range from 20 to 1500 m²/g, which is preferably determined as the apparent BET surface area.

In one embodiment of the present invention, flat carrier (D) is selected from metal meshes, for example steel meshes, especially stainless steel meshes, and also nickel meshes or tantalum meshes. Metal meshes may have coarse or fine pores.

In another embodiment of the present invention, flat carrier (D) is selected from electrically conductive fabrics, for example mats, felts or nonwovens of carbon or organic polymer which comprise metal filaments, for example tantalum filaments or nickel filaments.

Particularly suitable flat carriers (D) are, for example, metal foils, especially aluminum foils. Metal foils may have, for example, a thickness in the range from 4 μm to 200 μm, especially 20 to 50 μm.

The format of flat carrier (D) can be selected within wide ranges, for example in the form of continuous ribbons which can be processed by battery manufacturers. In other embodiments, flat carriers (D) may be configured, for example, in the form of round, elliptical or square sheets, or in cuboidal form, or in the form of flat electrodes.

In one embodiment of the present invention, mixture of sulfur (A), carbon (B) and at least one saccharide (C) can be compressed with flat carrier (D), for example at pressures in the range from 0.1 to 300 bar and temperatures in the range from zero to 150° C. For this purpose, it is possible to proceed from a paste or preferably from a pulverulent mixture, the layer height of which is adjusted with the aid of shims on flat carrier (D).

In one embodiment of the present invention, mixture of sulfur (A), carbon (B) and at least one saccharide (C) can be applied to one side of flat carrier (D).

In one embodiment of the present invention, mixture comprising sulfur (A), carbon (B) and at least one saccharide (C) is applied to only one side of flat carrier.

In one embodiment of the present invention, mixture of sulfur (A), carbon (B) and at least one saccharide (C) is applied to flat carrier (D) such that the layer thickness is within the range from 30 to 200 μm, preferably 60 to 120 μm, per layer, determined after drying.

The optional drying can be performed, for example, at a temperature in the range from 30 to 100° C., preferably in the range from 40 to 50° C.

The optional drying can be performed at standard pressure or preferably under reduced pressure, for example at 1 to 500 mbar.

Suitable equipment for a drying step includes refrigerators and especially vacuum refrigerators.

In one embodiment of the present invention, an aqueous formulation comprising
(A) sulfur,
(B) carbon in an electrically conductive polymorph and
(C) at least one saccharide (C)
   is applied to a metal film and then dried.

The flat carrier (D) thus coated can be used as an electrode in electrochemical cells.

Of course, it is possible to perform further steps for this purpose, for example connection to an output conductor.

Flat carriers (D) coated by the process according to the invention exhibit numerous advantages as electrodes in electrochemical cells. Examples include homogeneous sulfur distribution, good binding and contacting to the flat carrier (D) and a high sulfur utilization rate.

The present invention further provides electrodes comprising
(D) at least one flat carrier,
and thereon a mixture of
   (A) sulfur,
   (B) carbon in an electrically conductive polymorph and
   (C) at least one saccharide selected from monosaccharides, disaccharides and polysaccharides, which is soluble or swellable in an acidic aqueous medium.

Sulfur (A), carbon (B) and saccharide (C) are defined above.

In one embodiment of the present invention, carbon (B) is selected from graphite, graphene, carbon black and activated carbon, preferably from carbon black.

In one embodiment of the present invention, the inventive electrode comprises at least two, for example two or three, different kinds of carbon (B). Different kinds of carbon (B) may differ, for example, with regard to particle diameter or BET surface area or extent of contamination.

In one embodiment of the present invention, saccharides (C) are selected from glucose, fructose, sucrose, mannose and maltose.

In one embodiment of the present invention, saccharides (C) are selected from monosaccharides, especially glucose and fructose.

In one embodiment of the present invention, saccharides (C) are selected from disaccharides, especially sucrose.

In one embodiment of the present invention, saccharides (C) are selected from polysaccharides, especially amylopectin.

In one embodiment of the present invention, saccharides (C) are selected from partially oxidized saccharides, especially from partially oxidized mono- or disaccharides, especially from caramelized sugars, for example caramelized sucrose, caramelized glucose and caramelized fructose.

In one embodiment of the present invention, the coating of flat carrier (D) with sulfur (A), carbon (B) and saccharide (C) has a thickness in the range from 30 to 200 μm, preferably 60 to 120 μm per layer, determined after drying, i.e. in the case of application on both sides in a total thickness of 60 to 400 μm, preferably 120 to 240 μm.

Inventive electrodes are particularly suitable as a constituent of lithium-containing batteries. The present invention provides for the use of inventive electrodes as a constituent of or for production of electrochemical cells. The present invention further provides electrochemical cells comprising at least one inventive electrode.

In one embodiment of the present invention, the inventive electrode is the cathode, which can also be referred to as the sulfur cathode or S cathode. In the context of the present invention, the electrode referred to as the cathode is that at which the reduction reaction takes place in the course of discharge.

Inventive electrodes may have, for example, thicknesses in the range from 60 to 230 μm, preferably 90 to 150 μm. They may, for example, have a rod-shaped configuration, or be configured in the form of round, elliptical or square columns or in cuboidal form, or as flat electrodes.

In one embodiment of the present invention, inventive electrochemical cells comprise, as well as inventive electrode, at least one electrode which comprises metallic lithium or a lithium alloy, for example an alloy of lithium with tin, silicon and/or aluminum.

In one embodiment of the present invention, inventive electrochemical cells comprise, as well as inventive electrode and a further electrode, at least one nonaqueous solvent which may be liquid or solid at room temperature, preferably selected from polymers, cyclic or noncyclic ethers, cyclic and noncyclic acetals, cyclic or noncyclic organic carbonates and ionic liquids.

Examples of suitable polymers are especially polyalkylene glycols, preferably poly-C₁-C₄-alkylene glycols and especially polyethylene glycols. These polyethylene glycols may comprise up to 20 mol % of one or more C₁-C₄-alkylene glycols in copolymerized form. The polyalkylene glycols are preferably polyalkylene glycols double-capped by methyl or ethyl.

The molecular weight M_{w} of suitable polyalkylene glycols and especially of suitable polyethylene glycols may be at least 400 g/mol.

The molecular weight M_{w} of suitable polyalkylene glycols and especially of suitable polyethylene glycols may be up to 5 000 000 g/mol, preferably up to 2 000 000 g/mol.

Examples of suitable noncyclic ethers are, for example, diisopropyl ether, di-n-butyl ether, 1,2-dimethoxyethane, 1,2-diethoxyethane, preference being given to 1,2-dimethoxyethane. Further suitable noncyclic ethers are diethylene glycol dimethyl ether, triethylene glycol dimethyl ether, tetraethylene glycol dimethyl ether, diethylene glycol diethyl ether, triethylene glycol diethyl ether and tetraethylene glycol diethyl ether.

Examples of suitable cyclic ethers are tetrahydrofuran and 1,4-dioxane.

Examples of suitable noncyclic acetals are, for example, dimethoxymethane, diethoxymethane, 1,1-dimethoxyethane and 1,1-diethoxyethane.

Examples of suitable cyclic acetals are 1,3-dioxane and especially 1,3-dioxolane.

Examples of suitable noncyclic organic carbonates are dimethyl carbonate, ethyl methyl carbonate and diethyl carbonate.

Examples of suitable cyclic organic carbonates are compounds of the general formulae (I) and (II)

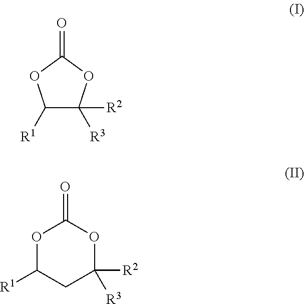

in which R¹, R² and R³ may be the same or different and are selected from hydrogen and C₁-C₄-alkyl, for example methyl, ethyl, n-propyl, isopropyl, n-butyl, isobutyl, sec-butyl and tert-butyl, where R² and R³ are preferably not both tert-butyl.

In particularly preferred embodiments, R¹ is methyl and R² and R³ are each hydrogen, or R¹, R² and R³ are each hydrogen.

The solvent(s) is (are) preferably used in what is known as the anhydrous state, i.e. with a water content in the range from 1 ppm to 0.1% by weight, determinable, for example, by Karl Fischer titration.

In one embodiment of the present invention, inventive electrochemical cells comprise one or more conductive salts, preference being given to lithium salts. Examples of suitable lithium salts are LiPF₆, LiBF₄, LiClO₄, LiAsF₆, LiCF₃SO₃, LiC(CₙF₂ₙ₊₁SO₂)₃, lithium imides such as LiN(CₙF₂ₙ₊₁SO₂)₂, where n is an integer in the range from 1 to 20, LiN(SO₂F)₂, Li₂SiF₆, LiSbF₆, LiAlCl₄, and salts of the general formula (CₙF₂ₙ₊₁SO₂)ₘXLi, where m is defined as follows:

m=1 when X is selected from oxygen and sulfur,
m=2 when X is selected from nitrogen and phosphorus, and
m=3 when X is selected from carbon and silicon.

Preferred conductive salts are selected from LiC(CF₃SO₂)₃ and LiN(CF₃SO₂)₂, and particular preference is given to LiN(CF₃SO₂)₂.

In one embodiment of the present invention, electrolytes of inventive electrochemical cells may comprise one or more additives, for example one or more ionic liquids.

In one embodiment of the present invention, inventive electrochemical cells comprise one or more separators by which the electrodes are mechanically separated. Suitable separators are polymer films, especially porous polymer films, which are unreactive toward metallic lithium and toward lithium sulfides and lithium polysulfides. Particularly suitable materials for separators are polyolefins, especially porous polyethylene in film form and porous polypropylene in film form.

Separators made from polyolefin, especially made from polyethylene or polypropylene, may have a porosity in the range from 35 to 45%. Suitable pore diameters are, for example, in the range from 30 to 500 nm.

In another embodiment of the present invention, the separators selected may be separators made from PET nonwovens filled with inorganic particles. Such separators may have a porosity in the range from 40 to 55%. Suitable pore diameters are, for example, in the range from 80 to 750 nm.

Inventive electrical cells are notable for particularly high capacitances, high performance even after repeated charging, and significantly delayed cell death. Inventive electrical cells are very suitable for use in automobiles, aircraft, ships or stationary energy stores. Such uses form a further part of the subject matter of the present invention.

The invention is illustrated by working examples.

General preliminary remark: In the context of the present invention, figures in percent are based on percent by weight, unless explicitly stated otherwise.

The following carbon blacks were used:

carbon black (B.1), commercially available as Ketjen®, BET surface area: 900 m²/g (measured to ISO 9277), mean particle diameter: 10 μm
carbon black (B.2), commercially available as Printex®, BET surface area: 100 m²/g (measured to ISO 9277), mean particle diameter: 10 μm

### I. Production of an Aqueous Formulation

### I.1 Production of an Aqueous Ink, WT1.1

A solution of 0.26 g of caramelized sucrose (C.1) in 73.5 g of a water-isopropanol mixture (weight ratio: 65:35) was stirred in a glass bottle. Subsequently, 2.8 g of sulfur flowers (A.1), 1 g of carbon black (B.1) and 1 g of carbon black (B.2) were added and stirring was continued. The suspension thus obtainable was ground in a ball mill (Pulverisette 6 from Fritsch) over a period of 30 minutes at 300 rpm. Thereafter, the balls were removed to obtain an aqueous ink which is also referred to hereinafter as WT1.1 and which had a creamy consistency.

### I.2 Production of an Aqueous Ink, WT1.2

A solution of 8.54 g of a 3% by weight aqueous amylopectin solution (C.2) in 77.5 g of a water-isopropanol mixture (weight ratio: 65:35) was stirred in a glass bottle. Subsequently, 2.73 g of sulfur flowers (A.1), 1 g of carbon black (B.1) and 1 g of carbon black (B.2) were added and stirring was continued. The suspension thus obtainable was ground in a ball mill (Pulverisette 6 from Fritsch) over a period of 30 minutes at 300 rpm. Thereafter, the balls were removed to obtain an aqueous ink, which is also referred to hereinafter as WT1.2 and which had a creamy consistency.

### II. Production of Inventive Electrodes

II.1 Application of inventive ink Wt1.1 and production of an inventive electrode electr.1

The substrate used was an aluminum foil, thickness 30 μm. Subsequently, inventive ink WT1.1 was sprayed with a spray gun on a vacuum table at a temperature of 75° C. onto the aluminum foil, and nitrogen was used for spraying. An aluminum foil coated on one side with a coating of 4 mg/cm² was obtained, calculated based on the sum of (A.1), (B.1) and (C.1).

Thereafter, the aluminum foil coated on one side was laminated cautiously between two rubber rollers. A low contact pressure was selected in order that the coating remains porous.

This was followed by thermal treatment in a drying cabinet, temperature: 40° C.

This gave an inventive electrode electr.1.

### II.2 Application of Inventive Ink WT1.2 and Production of an Inventive Electrode Electr.2

Example II.1 was repeated, except with inventive ink WT1.2 instead of with inventive ink WT1.1, to obtain an inventive electrode electr.2.

### III. Production of an Inventive Electrochemical Cell and Test

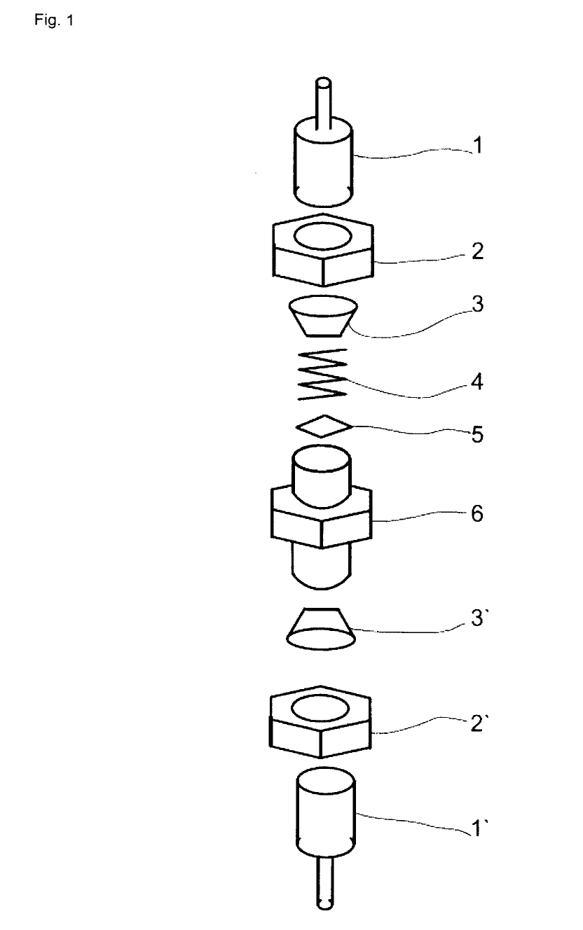

For the electrochemical characterization of the inventive electrodes electr.1 and electr.2, electrochemical cells were constructed according to FIG. 1. For this purpose, in addition to inventive electrodes, the following were used:

anode: Li foil, thickness 50 μm,
separator: polyethylene film, thickness 15 μm, porous
cathode according to example II.
electrolyte: 8% by weight of LiN(SO₂CF₃)₂, 46% by weight of 1,3-dioxolane and 46% by weight of 1,2-dimethoxyethane.

FIG. 1 shows the schematic structure of a dismantled electrochemical cell for testing of inventive electrodes.

The annotations in FIG. 1 mean:
1, 1′ die
2, 2′ nut
3, 3′ sealing ring—double in each case, the second, somewhat smaller sealing ring in each case is not shown here
4 spiral spring
5 output conductor made from nickel
6 housing

Inventive electrochemical cell EZ.1 (based on inventive electrode electr.1) or inventive electrochemical cell EZ.2 (based on inventive electrode electr.2) was obtained.

The inventive electrochemical cells exhibited an open circuit potential of 2.6 to 2.9 volts. During the discharge (C/10), the cell potential declined to 2.2 to 2.3 volts (1st plateau) and then to 2.0 to 2.1 volts (2nd plateau). The cells were discharged down to 1.7 V and then charged. During the charging operation, the cell potential rose to 2.2 volts, and the cell was charged until attainment of 2.5 volts. Then the discharging operation began again. The inventive electrochemical cells produced attained more than 30 cycles with only a very small loss of capacity.

1. A process for producing a cathode, which comprises mixing:
(A) sulfur,
(B) carbon in an electrically conductive polymorph and
(C) at least one saccharide selected from monosaccharides, disaccharides, oligosaccharides and polysaccharides, which is soluble or swellable in an acidic aqueous medium,
and applying the resulting mixture to a flat carrier (D) and then optionally drying it.

2. The process according to claim 1, wherein carbon (B) is selected from graphite, graphene, carbon black and activated carbon.

3. The process according to claim 1 or 2, wherein saccharides are selected from amylopectin.

4. The process according to claim 1 or 2, wherein saccharides are selected from glucose, fructose, sucrose, mannose and maltose.

5. The process according to any of claims 1 to 4, wherein saccharides are selected from partially oxidized saccharides.

6. The process according to any of claims 1 to 5, wherein an aqueous formulation comprising
(A) sulfur,
(B) carbon in an electrically conductive polymorph and
(C) at least one saccharide selected from monosaccharides, disaccharides and polysaccharides, which is soluble or swellable in an acidic aqueous medium,
is applied to a metal film
and then dried.

7. An electrode comprising
(D) at least one flat carrier,
and thereon a mixture of
(A) sulfur,
(B) carbon in an electrically conductive polymorph and
(C) at least one saccharide selected from monosaccharides, disaccharides and polysaccharides, which is soluble or swellable in an acidic aqueous medium.

8. The electrode according to claim 7, wherein carbon (B) is selected from graphite, graphene, carbon black and activated carbon.

9. The electrode according to claim 7 or 8, wherein saccharides are selected from amylopectin.

10. The electrode according to claim 7 or 8, wherein saccharides are selected from glucose, fructose, sucrose, mannose and maltose.

11. The electrode according to any of claims 7 to 10, wherein saccharides are selected from partially oxidized saccharides.

12. The use of electrodes according to any of claims 7 to 11 in electrochemical cells.

13. An electrochemical cell comprising at least one electrode according to any of claims 7 to 11.
